(19) United States
(12) Patent Application Publication
(10) Pub. No.: US 2002/0119302 A1
(43) Pub. Date: Aug. 29, 2002

(54) Coating composition and method

(75) Inventor: Robert V. Fritz, Clinton Township, MI (US)

Correspondence Address: Jordan and Hamburg LLP, 122 East 42nd Street, New York, NY, 10168, US

(73) Assignee: Nippon Paint Co., Ltd.

(21) Appl. No.: 09/748,820

(22) Filed: Dec. 22, 2000

(51) Int. Cl. B32B 5/16

(52) U.S. Cl. 428/325; 524/494

(57) ABSTRACT

A coating composition providing enhanced sparkling sheen in both the face color and the down flop color includes a glass material in the form of randomly shaped chips having an irregularly-shaped particulate geometry which are dispersed in a carrier. The chips have a particle size/D₁₀-D₉₀ ranging from about 1 to 30 μm, preferably about 1 μm to about 16 μm, and more preferably about 2 to 12 μm and average aspect ratio/D₉₀ in a range of about 1 to 4. The composition can further include another luster pigment advantageously provided as glass beads having a particle size/D₁₀-D₉₀ in a range of about 0.1 to 12 μm, preferably about 0.2 to 12 μm, and more preferably about 0.3 to 6.5 μm. In an advantageous further embodiment, a flaky pigment comprised of a cholesteric liquid crystal polymer is added to the above described compositional embodiments to impart a dichroism to a film coating formed of such composition. The cholesteric liquid crystal polymer for use in such coating composition is a material having a three-dimensionally crosslinked cholesteric liquid crystal structure having a helical structure and expressing a dichroism, i.e., a chromatic phenomenon resulting in differences in color shade according to the angle of view.

### BACKGROUND OF THE INVENTION

The present invention relates to a coating composition comprising a glass material having a defined particle geometry dispersed in a carrier, a method of forming a film coating using such composition, and a multilayer film coating obtainable by the method. The invention further relates to a coating composition which additionally comprises a flaky pigment composed of a cholesteric liquid crystal polymer for imparting dichroism.

Luster coatings containing glass flakes or metal-coated glass flakes are known in the art. Examples of such luster coatings comprising metal-coated glass flakes are described in Japanese Kokai Publication Hei-5-1248 and Japanese Kokai Publication Hei-5-1799174. Such metallic pigments are capable of providing film coatings with an enhanced sparkling sheen as compared with conventional aluminum flake pigment.

Although a film coating comprising metal-coated glass flakes or uncoated glass flakes as mentioned above expresses an intense sparkling sheen in the face color as viewed from the front of the film coating, such coating does not express a sparkling sheen in the down flop color of the film coating as viewed from an oblique direction.

In accordance with another type of film coating, a flaky pigment composed of a cholesteric liquid crystal polymer and an interference pigment composed of titanium dioxide-coated glass flakes have heretofore been employed to obtain a dichroism, i.e., a chromatic variance phenomenon resulting in differences in color shade according to different angles of view, as disclosed, for example, in Japanese Patent 3047122. However, since a titanium dioxide-coated glass flake is used in combination with a flaky pigment, a sparkling sheen is obtained in the face color, but no sparkling sheen can be obtained in the down flop color.

Therefore, a demand exists for a film coating which is not only capable of providing a highly sparkling sheen in both the face color and the down flop color, but which, when optionally combined with additives achieving dichroism, permits such effect to be perceived with a sparkling sheen even when viewed at an oblique angle to the coated surface.

Accordingly, it is an object of the invention to provide a coating composition which contains a glass material having a defined particle geometry which overcomes the drawbacks of the prior art.

It is a further object of the invention to provide a method of forming a film coating having the aforementioned characteristics, and a multilayer film coating obtainable by the method.

It is yet a further object of the invention to provide a coating composition which contains a glass material having a defined particle geometry which attains an intense sparkling sheen not only in the face color but also in the down flop color of the film coating.

It is still a further object of the invention to provide a coating composition which offers enhanced versatility by virtue of a concomitant heat barrier effect.

A still further object of the invention is to provide a coating composition capable of expressing a markedly intense sparkling sheen in both the face color and the down flop color, as well as a dichroism, through the use of glass material having a defined particle geometry and a flaky pigment composed of a cholesteric liquid crystal polymer, a method of forming a film coating having such composition, and a multilayer film coating obtainable by such method.

### SUMMARY OF THE INVENTION

In accordance with these and other objects of the invention, there is provided a coating composition comprising a glass material in the form of randomly shaped chips having an irregularly-shaped particulate geometry which are dispersed in a carrier.

Briefly stated, the invention is directed to a coating composition comprised of particulate glass material dispersed in a suitable carrier. The glass material is provided in the form of randomly shaped glass chips having a particle size/D₁₀-D₉₀ ranging from about 1 to 30 μm (i.e., D₁₀≧1 μm and D₉₀≦30 μm), preferably about 1 to 16 μm (i.e., D₁₀≧1 μm and D₉₀≦16 μm), and more preferably about 2 to 12 μm (i.e., D₁₀≧2 μm and D₉₀≦16 μm) and an average aspect ratio/D₉₀ in a range of about 1 to 4.

Particularly from an environmental standpoint, the randomly shaped chips of glass advantageously comprise irregularly shaped recycled glass particles.

In accordance with a further embodiment of the invention, another luster pigment is added to the coating composition comprised of randomly shaped glass chips mentioned above. The luster pigment is specifically in the form of glass beads, and is used in combination with the above-described randomly shaped chips, both being dispersed in a suitable carrier as defined above herein. The particle size/D₁₀-D₉₀ of the glass beads which are combined with the randomly shaped chips is in a range of about 0.1 to 12 μm, preferably about 0.2 to 12 μm, and more preferably about 0.3 to 6.5 μm. Glass beads or spheres are thought to increase the sparkle magnification effected achieved by use of the randomly shaped glass chips alone by assisting in internal dispersion of light within a film coating. It is theorized that light impinging the curve of the bead surface creates dispersed light which enters the glass chips at multiple angles, and thereby intensifies the perceived sparkle.

In an advantageous further embodiment, a flaky pigment comprised of a cholesteric liquid crystal polymer is added to the above described compositional embodiments to impart a dichroism to a film coating formed of such composition. The cholesteric liquid crystal polymer for use in the coating composition according to this embodiment in accordance with the invention is a material having a three-dimensionally crosslinked cholesteric liquid crystal structure having a helical structure and expressing a dichroism, i.e., a chromatic phenomenon resulting in differences in color shade according to the angle of view.

Because of the enhanced sparkling sheen and heat barrier properties, as well as dichroism in both the face color and the down flop color when such further embodiment is practiced, the multilayer film coating of the present invention finds application, with particular advantage, in the coating of visible surfaces of automobiles and bicycles, associated parts, exterior surfaces of various vessels and containers, coils, furniture, and household electrical appliances and communications equipment where sparkling sheens are required.

The glass chips and beads or spheres add product safety at night. When a source of light strikes a painted glass surface, the coating produces a bright flash of “scattered reflectivity”, increasing the surface's visibility to other viewers at night.

### BRIEF DESCRIPTION OF THE DRAWINGS

FIG. 1 is a photograph of glass flakes;

FIG. 2 is a photograph of mica flakes;

FIG. 3 is a photograph of randomly shaped glass chips in accordance with an embodiment of the invention;

FIG. 4A and 4B are a schematic diagrams of the analysis carried out on the samples of the application examples and the comparative examples; and

FIG. 5 is a graphical plot of quantitative evaluation data for Application Example 34 and Comparative Example 5 in the form of a distribution curve;

### DETAILED DESCRIPTION OF THE INVENTION

Coating Composition

The coating composition of the present invention broadly comprises glass material having an irregularly-shaped particle geometry (the particulate glass material also referred to herein by the term “randomly shaped glass chips” or simply “randomly shaped chips”) which is dispersed in a carrier. In accordance with an advantageous embodiment of the invention, particularly from an environmental standpoint, the glass material comprises finely divided fragments of recycled glass in the form of randomly shaped chips.

The film coating obtainable by using the above-described irregularly-shaped particulate glass material expresses an intense sparkling sheen not only in the face color but also in the down flop color and concomitantly offers a heat barrier effect for added versatility and advantage.

In accordance with an embodiment of the invention, the randomly shaped glass chips have a particle size/D₁₀-D₉₀ ranging from about 1 to 30 μm, preferably about 1 to 16 μm, and more preferably about 2 to 12 μm and average aspect ratio/D₉₀ in a range of about 1 to 4.

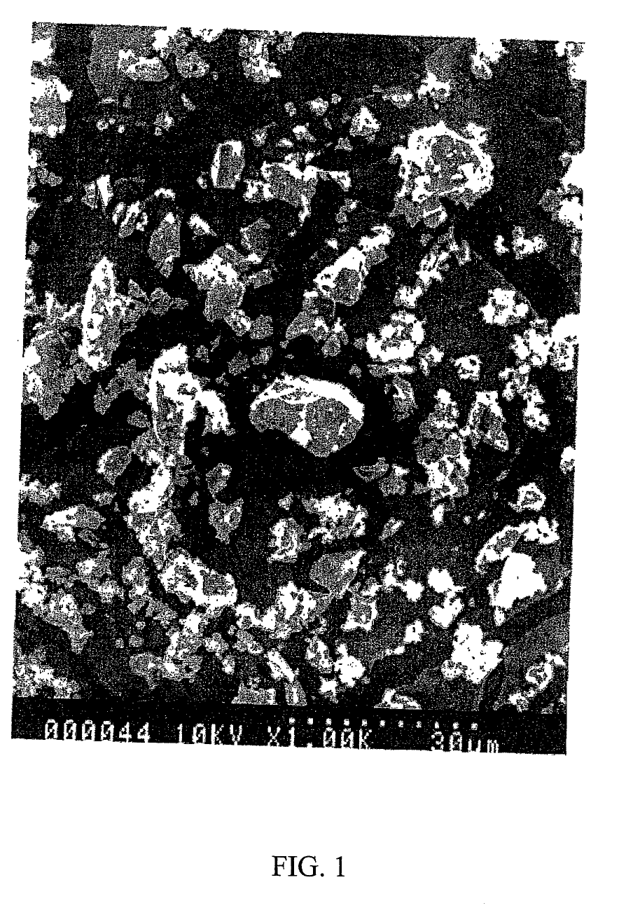

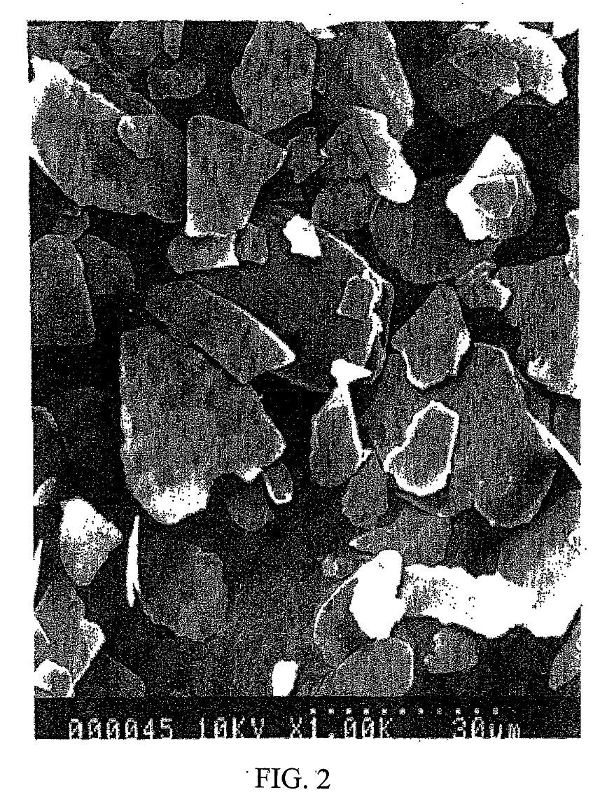

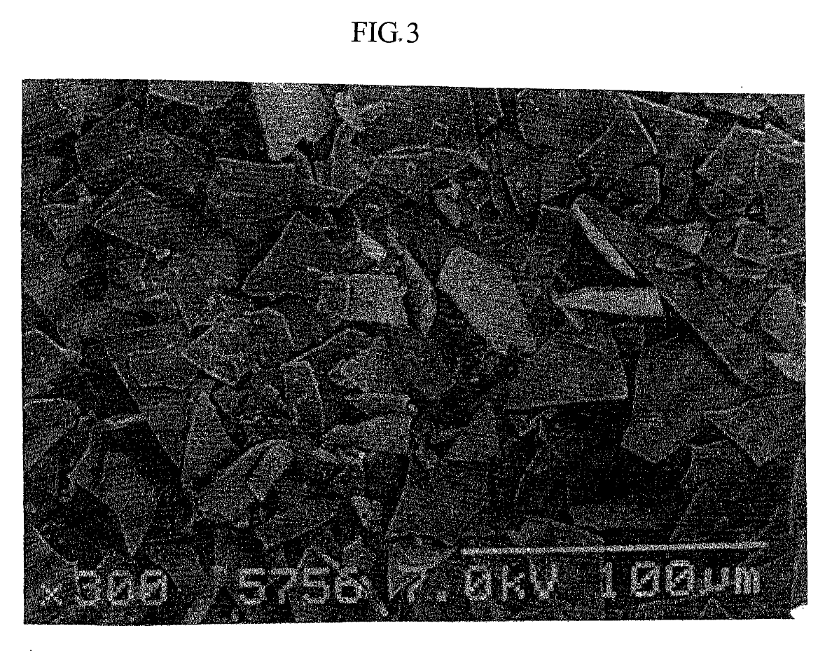

As noted above, and particularly from an environmental standpoint, the randomly shaped chips of glass advantageously comprise irregularly shaped recycled glass particles. These are obtained, for example, by washing used glass bottles, sheet glass, automotive glass, mirrors, etc., pulverizing them, classifying the resulting fragments with a sieve, further comminuting the coarse residues remaining on the sieve and further classifying the resulting fragments. FIGS. 1 and 2 are photographs of glass chips and mica chips, respectively, for film coatings of the prior art whereas FIG. 3 is a photograph of an example of randomly shaped glass chips for film coatings of the invention.

A multilayer coating film formed from this composition expresses a remarkably intense sparkling sheen in both the face color (i.e., color perceived when the colored surface is viewed directly and the down flop color (i.e., color perceived when the colored surface is viewed obliquely). In addition, the inventive coating film provides further versatility by virtue of the concomitant heat barrier properties obtained by use thereof.

In accordance with an advantageous further embodiment, incorporated in the coating composition of the present invention is a flaky pigment comprising a cholesteric liquid crystal polymer and dispersed in a carrier. A multilayer coating film formed from this composition expresses a remarkably intense sparkling sheen and dichroism in both the face color and the down flop color. In addition, the coating film thus obtained demonstrates concomitant heat barrier properties for added versatility.

It is noted that, in a coating containing microspheres, an average maximum particle length/average minimum particle length ratio is theoretically equal to 1. However, for purposes of the invention, as disclosed herein, the randomly shaped chips advantageously comprise irregularly-shaped particulate glass material which does not contain microspheres at a ratio of 1, the randomly shaped chips having an average aspect ratio/D₉₀ in a range of about 1 to 4.

Such characteristics have not been observed in connection with the conventional flaky glass, an average aspect ratio/D₉₀ if which is about 50 to 100.

By applying the above-described criteria, the glass material according to the present invention imparts an intense sparkling sheen to a coating, not only in the face color, i.e., the color perceived when facing the colored surface squarely, but also, in particular, in the down flop color, i.e., color observed when viewing the colored surface obliquely. Such characteristics have not been observed in connection with the conventional flaky glass.

The weight proportion of the above-mentioned irregularly-shaped particulate glass material in the coating composition of the invention (the weight proportion of the glass, which may be referred to as “pigment”, material relative to the total solids content of the coating composition, i.e., “PWC”, “pigment” weight content) is preferably about 0.01% to about 50% by weight, and more preferably about 1% to about 30% by weight. If the glass material only accounts for less than about 0.01%, the objective intense sparkling sheen may not only be absent in the down flop color, but possibly also in the face color as well. Conversely, if the weight proportion of glass exceeds about 50%, the appearance of the coating film may not be as ideally desired.

In accordance with various embodiments of the present invention, the randomly shaped chips need not be fully transparent, and in addition to clear glass, may also be comprised of a colored glass of particular hue. Use of such colored glass chips which are of primary, secondary and tertiary colors, respectively, provides the advantage of having ultraviolet absorbing properties, and when employed in a coating, can reduce the required amount of other color pigments. This way of reducing the required amount of other colored pigments may be referred to as color extensions for blends of primary colors, secondary colors and tertiary colors, i.e., the science of color blending.

The coating composition of the present invention is a dispersion of the aforementioned randomly shaped chips, having the defined size characteristics and geometry described above, in a carrier. Such carrier comprises a coating film-forming resin and, when necessary, a crosslinking agent. The coating film-forming resin, which constitutes the carrier, includes, among others, acrylic resins, polyester resins, alkyd resins, fluororesins, epoxy resins, polyurethane resins and polyether resins. These may be used singly, or two or more of them may be used combinedly. Examples of each are grouped together below by general category.

Acrylic resins

As the above acrylic resins, suitable examples include copolymers of an acrylic monomer and another ethylenically unsaturated monomer. The acrylic monomer, which can be used in this copolymerization include the methyl, ethyl, propyl, n-butyl, isobutyl, tert-butyl, 2-ethylhexyl, lauryl, phenyl, benzyl, 2-hydroxyethyl, 2-hydroxypropyl and like esters of acrylic acid or methacrylic acid, ring-opening adducts of caprolactone to 2-hydroxyethyl acrylate or methacrylate, glycidyl acrylate or methacrylate, acrylamide, methacrylamide and N-methylolacrylamide, among others. Other ethylenically unsaturated monomers copolymerizable with these include styrene, a-methylstyrene, itaconic acid, maleic acid, vinyl acetate and the like.

Polyester resins

As the above polyester resins, suitable examples include saturated polyester resins and unsaturated polyester resins, among others, for example condensation products obtained by subjecting a polybasic acid and a polyhydric alcohol to condensation under heating. The polybasic acids include, for example, saturated polybasic acids, unsaturated polybasic acids. The saturated polybasic acids include, among others, phthalic anhydride, terephthalic acid and succinic acid, while the unsaturated polybasic acids include, among others, maleic acid, maleic anhydride and fumaric acid. The polyhydric alcohol includes, for example, dihydric alcohols, such as ethylene glycol and diethylene glycol, and trihydric alcohols, such as glycerol, trimethylolpropane and the like.

Alkyd resins

Useful as the above alkyd resins are those alkyd resins produced by reacting together such a polybasic acid as mentioned above and such a polyhydric alcohol as mentioned above and, further, a modifier such as a fat or oil or a fat-or oil-derived fatty acid (e.g. soybean oil, linseed oil, coconut oil, stearic acid) or a natural resin (e.g. rosin, amber).

Fluororesins

The above fluororesins include vinylidene fluoride resins, tetrafluoroethylene resins, mixture of these, and various fluorine-containing copolymer resins resulting from copolymerization of a fluoroolefin(s) and a hydroxy-containing polymerizable compound and some other copolymerizable vinyl compound(s).

Epoxy resins

The above epoxy resins include, among others, resins produced by reacting a bisphenol and epichlorohydrin. The bisphenol includes bisphenol A and bisphenol F, for instance. As such bisphenol-based epoxy resins, there may be mentioned, for example, “Epikote 828”, “Epikote 1001”, “Epikote 1004”, “Epikote 1007” and “Epikote 1009” (all products of Shell Chemical). Those derived from these by chain extension using an appropriate chain extender agent may also be used.

Polyurethane resins

As the above polyurethane resins, suitable examples include urethane bond-containing resins derived from at least one of various polyol components, such as acrylic, polyester, polyether or polycarbonate polyols, and at least one polyisocyanate compound. The polyisocyanate compound is, for example, 2,4-tolylene diisocyanate (2,4-TDI), 2,6-tolylene diisocyanate (2,6-TDI), a mixture of these (TDI), diphenylmethane-4,4′-diisocyanate (4,4′-MDI), diphenylmethane-2,4′-diisocyanate (2,4′-MDI), a mixture thereof (MDI), naphthalene- 1,5-diisocyanate (NDI), 3,3′-dinethyl-4,4′-biphenylene diisocyanate (TODI), xylylene diisocyanate (XDI), dicyclohexylmethanediisocyanate (hydrogenated HDI), isophoronediisocyanate (IPDI), hexamethylene diisocyanate (HDI), hydrogenated xylylene diisocyanate (HXDI) or the like.

Polyether resins

As the above polyether resins, suitable examples include ether bond-containing polymers or copolymers, such as polyoxyethylene polyethers, polyoxypropylene polyethers, polyoxybutylene polyethers, polyethers derived from an aromatic polyhydroxy compound such as bisphenol A or bisphenol F, like polyether resins having at least two hydroxy groups per molecule, and carboxyl-containing polyether resins obtained by reacting the polyether resins mentioned above with a polybasic carboxylic acid, such as succinic acid, adipic acid, sebacic acid, phthalic acid, isophthalic acid, terephthalic acid or trimellitic acid, or a reactive derivative thereof, such as the acid anhydride.

While coating film-forming resins are available in two types, namely the curable type and the lacquer type, usually a curable type resin is employed. In the case of a curable type resin, it is mixed with an amino resin, a (blocked) polyisocyanate compound, or an amine, polyamide or polycarboxylic acid type crosslinking agent, and the curing reaction is caused to proceed under heating or at atmospheric temperature. Moreover, a non-curable lacquer type coating film-forming resin may be used in combination with such a curable resin.

In cases where the above carrier contains a crosslinking agent, the ratio between the coating film-forming resin and crosslinking agent on the solid basis is such that the coating film-forming resin accounts for 90 to 50% by weight and the crosslinking agent for 10 to 50% by weight, preferably such that the coating film-forming resin accounts for 85 to 60% by weight and the crosslinking agent for 15 to 40% by weight. When the crosslinking agent is used in an amount less than 10% by weight (or the coating film-forming resin is used in an amount exceeding 90% by weight) or the amount of the crosslinking agent is in excess of 50% by weight (or the amount of the coating film-forming resin is less than 50% by weight), crosslinking in the coating film will be insufficient.

In addition to the glass material described above, the coating composition of the present invention may contain other luster and/or color pigments at a suitable level not detracting from the effect of incorporation of said glass material.

Suitable examples of other luster pigments include, among others, aluminum flake pigments, colored aluminum flake pigments, mica pigments, metallic titanium flakes, alumina flake pigments, silica flake pigments, graphite pigments, stainless steel flakes, flake glass, glass beads, platelet-like iron oxide and phthalocyanine flakes. As a color pigment, suitable materials include, for example, such organic pigments as azo lake pigments, phthalocyanine pigments, indigo pigments, perylene pigments, quinophthalone pigments, dioxazine pigments, quinacridone pigments, isoindolinone pigments and metal complex pigments and such inorganic pigments as chrome yellow, yellow iron oxide, red iron oxide, titanium dioxide and carbon black. The addition amount of another luster pigment and/or the color pigment can be arbitrarily selected unless it disturbs the effect of the glass material and/or compound shade blending with the under coating. The weight-based mixing ratio (the above glass material/another luster pigment and/or color pigment) is preferably 99/1 to 10/90. Any of various extender pigments can also be used combinedly.

In addition to the above components, the coating composition of the invention may further incorporate a polyamide wax, which is a lubricating dispersion of an aliphatic amide, a polyethylene wax, which is a colloidal dispersion mainly composed of oxidized polyethylene, an antisettling agent, a curing catalyst, an ultraviolet absorber, an antioxidant, a leveling agent, a surface modifier such as a silicone or an organic polymer, an antisagging agent, a thickening agent, an antifoam, a lubricant, crosslinking polymer particles (microgel) and/or the like. By incorporating these additives in an amount of not more than 15 parts by weight per 100 parts by weight (on the solid basis) of the above vehicle, it is generally possible to improve the performance characteristics of the coating composition and/or film coating.

In accordance with a further embodiment of the invention, another luster pigment is added to the coating composition comprised of randomly shaped glass chips mentioned above. The luster pigment is specifically in the form of glass beads, and is used in combination with the above-described randomly shaped chips, both being dispersed in a suitable carrier as defined above herein. The particle size/D₁₀-D₉₀ of the glass beads which are combined with the randomly shaped chips is in a range of about 0.1 μm to about 12 μm, preferably about 0.2 μm to about 12 μm, and more preferably about 0.3 μm to about 6.5 μm. Glass beads are thought to magnify the sparkle effect achieved by use of the randomly shaped glass chips alone by assisting in internal dispersion of light within a film coating. It is theorized that light impinging the curve of the bead surface creates dispersed light which enters the glass chips at multiple angles, and thereby intensifies the perceived sparkle. In a further embodiment, the aforementioned glass beads comprise finely divided glass beads of recycled glass.

In an embodiment in accordance with the invention in which randomly shaped chips glass comprised of clear or lightly-hued glass are combined with glass beads, the weight ratio of randomly shaped chips/beads is advantageously in a range of about 9/1 to about 5/5 , and in a more preferable range of about 7/3 to about 6/4 . In another embodiment, in which the randomly shaped chips glass are comprised of relatively darkly-hued glass, and in accordance with which such chips are combined with glass beads, the weight ratio of randomly shaped chips/beads is advantageously in a range of about 8/2 to about 3/7 , and more preferably in a range of about 6/4 to about 4/8.

In an advantageous further embodiment, a flaky pigment comprised of a cholesteric liquid crystal polymer is added to the above described compositional embodiments to impart a dichroism to a film coating formed of such composition. The cholesteric liquid crystal polymer for use in the coating composition according to this embodiment in accordance with the invention is a material having a three-dimensionally crosslinked cholesteric liquid crystal structure having a helical structure and expressing a dichroism, i.e., a chromatic phenomenon resulting in differences in color shade according to the angle of view.

The flaky pigment comprised of a cholesteric liquid crystal polymer can be typically produced by using a three-dimensionally crosslinkable polymer such as a polyorganosiloxane compound having a methacryloxy or acryloxy side chain, and a liquid crystal compound as starting materials, aligning the molecules in parallel layers, superimposing the layers in slightly displaced molecular orientations by application of an electric field or magnetic field to thereby form a helical structure, and carrying out a polymerization reaction to immobilize the molecules as oriented and crosslink the thin layers three-dimensionally, isolating the polymer from a substrate, and pulverizing the polymer to the necessary particle size.

Since the flaky pigment comprised of such a liquid crystal polymer has a helical structure, the reflection wavelength range depends on the pitch of the helix and the refractive index of the liquid crystal. Furthermore, the reflection light of a wavelength within a given range is split into polarized components by a helical structure with the pitch equal to the wavelength of the light and becomes a reflected light component and a transmitted light component depending on the direction of rotation of the helix. The change in the angle of view results in a change in the pitch of the helix to develop a dichroism of varying in shade according to the angle of view. In the present invention, other colorants and/or color pigments may be added to the flaky pigment comprised of a liquid crystal polymer.

The major-axis diameter of the flaky pigment comprised of a liquid crystal polymer is preferably about 1 μ to about 100 μm, and more preferably about 10 μm to about 60 μm, and the average thickness of the flakes is preferably about 2 μm to about 15 μm, and more preferably about 3 μm to about 10 μm.

Suitable examples of the above described flaky pigment comprised of a liquid crystal polymer which can be utilized in preparing a coating composition in accordance with the present embodiment of the invention are available as commercial products from Wakker Chemical Co. as the “Helicone”™ series, namely “Helicone 450 Blue”™ (blue˜dark), “Helicone 516 Green”™ (green˜blue), “Helicone 575 Gold”™ (gold˜greenish blue), and “Helicone 624 Copper-red”™ (copper red˜green).

The formulating ratio of the glass material (including the combined weight of glass chips and beads when such embodiment is employed) to the flaky pigment comprised of a cholesteric liquid crystal polymer on a solid basis by weight is in a range of about 30/70 to about 80/20. If this ratio is less than 30/70 (i.e. the proportion of the glass material is smaller), the sparkling sheen in the down flop color may not be obtained. On the other hand, if the ratio exceeds 80/20 (i.e. the proportion of the flaky pigment comprised of a cholesteric liquid crystal polymer is smaller), the dichroism may not be obtained.

The coating composition in accordance with the invention, and as exemplified above by way of the various described embodiments, is provided generally in the form of a solution or dispersion prepared from the above components and a solvent. The solvent may be any one capable of dissolving or dispersing the carrier. Thus, an organic solvent and/or water can be used. The organic solvent includes those conventionally used in the field of coatings, for example hydrocarbons such as toluene and xylene, ketones such as acetone and methyl ethyl ketone, esters such as ethyl acetate, cellosolve acetate and butylcellosolve, and alcohols. Where the use of organic solvents is regulated from the environmental viewpoint, water is preferably used. In that case, the water may contain an appropriate amount of a hydrophilic organic solvent.

Furthermore, in the practice of the present invention, the glass material can be added to a water-based coating, where the preheating procedure generally interposed prior to application of a clear top coating results in a better orientation of glass flakes in the luster coating film so that a still more remarkable improvement can be realized in the sparkling sheen in both the face color and the down flop color.

Coating film-forming method

The method of forming a film coating according to the present invention comprises forming a multilayer film coating on a substrate, wherein at least one multilayer film coating is formed from the coating composition described above. The invention further provides a method of forming a multilayer film coating comprising a base coat, a luster coat formed from the coating composition in accordance with an embodiment of the invention (which coat includes the lusterimparting randomly shaped chips), and a clear top coat. The resulting film coating not only demonstrates a good sheen, but also provides heat-barrier properties.

The above substrate includes, but is not limited to, metals such as iron, aluminum, copper, and alloys thereof; inorganic materials such as glass, cement and concrete; plastic materials, inclusive of resins such as polyethylene resins, polypropylene resins, ethylene-vinyl acetate copolymer resins, polyamide resins, acrylic resins, vinylidene chloride resins, polycarbonate resins, polyurethane resins and epoxy resins, and various kinds of FRP (i.e., fiber-reinforced plastics); natural or synthetic materials such as wood, paper, cloths and other fibrous materials; and so forth.

In accordance with the above coating film-forming method, the above coating composition is applied to the above substrate either directly or through the intermediary of an under coat. When an outer panel of an automobile, automotive fitting, part or like article is coated by the above coating film-forming method of the invention, it is preferred that the substrate be preliminarily subjected to chemical conversion treatment, primer coating, intermediate coating and the like by electrodeposition coating, powder coating or the like. The intermediate coating application is carried out for providing substrate masking effects and chipping resistance, securing adhesion to the top coat.

In the practice of the present invention, an intermediate coating can be applied to construct a base coat on the substrate prior to formation of the luster coat. When a base coat has been formed, the base coat is preferably constructed after baking the under coat. The base coat may be formed using a solvent-based coating, a water-based coating, or a powder coating. The vehicle, pigment and optional additives in the coating for construction of the base coat may all be the same as mentioned for the coating composition of the invention. Usually, however, the base coat is formed from a gray series base coating. The base coat may be designed to double as a base coat and an intermediate coat as well.

The dry thickness of the base coat is preferably about 10 μm to about 250 μm. The appearance of this film coating tends to be adversely affected by deviation from this range. The more preferred thickness range is 20 μm to 150 μm.

In accordance with the method in accordance with the invention, a luster coat is formed from the coating composition comprising the randomly shaped chips either directly on the substrate, or on the above described base coat, when present. This luster coat is formed on the base coat which has been baked or which has not been baked. The dry thickness of such a luster coat is preferably about 10 μm to 100 μm, and more preferably about 20 μm to about 50 μm. By using a system prepared with controlled amounts and species of glass material and other luster and/or color pigments as the coating composition, a transparent film coat can be prepared and by using such a transparent recipe, a compound shade blending with the under coat and/or base coat can be expressed.

Further, when a sparkling sheen is desired, at least one clear top coat is constructed on top of the luster coat. When the luster coat is rich in glass material, the surface flatness of the coating film can be improved by applying the clear top coating in two or more layers. The dry thickness of the clear top coating film is preferably about 30 μm to about 400 μm. Outside this range, the appearance of the coating film may not be as satisfactory as desired. The more preferred thickness range is about 50 to 200 μm.

For the construction of this clear top coat, a standard clear coating can be employed, and optionally a clear coating colored with a dye or a color pigment can also be employed, but only to an extent which does not adversely impair the transparency of such clear coat. Moreover, the clear top coat may be formed from a solvent-based coating, a water-based coating, or a powder coating. The solvent-based or water-based coating may be a one-component coating or a two-component coating such as a two-component urethane resin coating. By constructing a clear top coat on the luster coat, an improvement in sheen as well as protection of said glass material against damage can be expected. The material used for the clear coat may be any of those generally used for top coating, for example mixtures of at least one thermosetting resin with a crosslinking agent. However, the following are preferred for the reasons listed: a clear coating comprising a carboxyl-containing polymer and an epoxy-containing polymer, as described in Japanese Kokoku Publication Hei-08-19315, because such composition serves as a measure against acid rain and because the luster pigment orientation in the luster coating film will not be disturbed in the step of applying a clear top coating without baking a luster coating; two-component urethane resin coating in view of curing at lower temperature; and powder coating in view of environmental preservation. The clear coating mentioned above may further contain, when necessary, a color pigment, an extender pigment, a modifier, an ultraviolet absorber, a leveling agent, a dispersant, an antifoam and/or a like additive, each in an amount within the range within which the transparency of the composition will not be sacrificed.

In accordance with an alternative embodiment of the invention, a multilayer film coating does not include a clear top coat formed on the luster coat comprised of the randomly shaped glass chips. Such multilayer film coating expresses a vibrant, satin sheen with enhanced anti-marring characteristics and which reduces the appearance of fingerprints and improves surface wear and polish back characteristics.

The application of each coating of a multilayer film coating in accordance with the invention is carried out by generally practiced methods, for example, rotary atomizing method, air atomizing method, roll coater method, electrodeposition coating method or the like is preferred, however. Coatings may, where necessary, be baked at about 80° C. to about 160° C. for an appropriate period.

Multilayer coating film

The multilayer coating film of the present invention comprises the above-described luster coat as at least one component layer. In the preferred case, the coating film comprises a base coat, a luster coat and a clear top coat, built up in succession. This architecture insures a multilayer coating film expressing a sparkling sheen in both the face color and the down flop color and even having a heat barrier effect.

### EXAMPLES

The following application examples and comparative examples illustrate the present invention in further detail. These examples are, however, by no means limitative of the scope of the invention. Unless otherwise specified, “part(s)” means “part(s) by weight”.

Application Examples 1 to 38 and Comparative Examples 1 to 7

Substrate preparation

Dull steel sheets (300 mm long, 100 mm wide and 0.8 mm thick) were subjected to chemical conversion treatment using a phosphatizing agent and then electrodeposition-coated with a cationic electrodeposition coating to a dry film thickness of 25 μm. Then, following 30 minutes of baking at 160° C., a polyester/melanine resin type base coating was applied by air spraying to a dry film of 40 μm, followed by 30 minutes of baking at 140° C. to provide substrates.

Preparation of coating compositions (Application Examples 1-19)

A carrier 1 was prepared by admixing an acrylic resin (styrene/methyl methacrylate/ethyl methacrylate/hydroxyethyl methacrylate/methacrylic acid copolymer with a number average molecular weight of about 20,000, a hydroxyl value of 45, an acid value of 15 and a solid content of 50% by weight) with a buthylated melamine resin in a solid weight ratio of 80:20. A carrier 2 was prepared by admixing an amine-neutralized aqueous acryl resin (a hydroxyl value of 50, an acid value of 70 and a solid content of 50% by weight) with a methylated melamine resin in a solid weight ratio of 80:20. Such carriers were respectively blended with glass material and, where necessary, another pigment, species and the proportions of which are shown in Table 1. Coating compositions were then prepared by mixing, under stirring in a dissolver, respectively with an organic solvent (toluene/xylene/ethyl acetate/butyl acetate=70/15/10/5, by weight: for carrier 1) or water (for carrier 2) until a viscosity adequate for application was attained.

Preparation of multicolor coating compositions (Application Examples 20-38)

The above-mentioned carriers were respectively blended with glass material, a flaky pigment comprised of a cholesteric liquid crystal polymer and, where necessary, another pigment, the species and the proportions of which are shown in Table 2.

Clear top coat

The following materials were used in preparing clear top coats 1 and 2:

Top coat 1: an acrylic/melamine resin-based clear coating

Top coat 2: a clear coating comprising a blend of a carboxyl-containing polymer and an epoxy-containing polymer.

Construction of a multilayer film coating (Application Examples 1-19)

On the substrate surface to be coated, a luster coat was formed using the coating composition according to the recipe shown in Table 1 in a dry thickness of 30 μm. Then, on this luster coat constructed using the carrier 1, a clear top coat was built up in a dry thickness of 50 μm without baking such luster coat. The baking conditions were 140° C. for 20 minutes. The luster coat constructed using the carrier 2 was preheated by infrared at 80° C. for 5 minutes, and the clear top coat was applied in a dry thickness of 50 μm to provide a multilayer film coating. The baking conditions were 140° C. for 20 minutes. The sheen and heat barrier characteristics of the film coatings obtained were evaluated by the evaluation methods described below.

Construction of a multicolor film coating (Application Examples 20-38)

The criteria described above with regard to the multilayer film coatings of Application Examples 1-19 were implemented, in which a luster coat was formed using the coating composition according to the recipe shown in Table 2. The sheen and dichroism characteristics of the film coatings obtained were evaluated by the evaluation methods described below.

Evaluation Criteria for Application Examples 1-19 and Comparative Examples 1-3

Sheen: Each sheen perceived when each sample sheet was viewed approximately from the front (face color) and from an oblique direction (down flop color) was evaluated by gross observation on the following scoring scale.

4-Markedly intense sparkling sheen in both the face color and the down flop color

3-Intense sparkling sheen in both the face color and the down flop color

2-Slight sparkling sheen in both the face color and the down flop color

1-No intense sparkling sheen in the down flop color

Heat barrier effect: Each sample was exposed to outdoor sunlight for 1 hour from the noontime on a clear day at an atmospheric temperature of 30° C. and the surface temperature of the coating film was measured and graded on the following scoring scale.

3-Surface temperature of coating film <50° C.

2-50° C.=surface temperature of coating film <60° C.

1-60° C.=surface temperature of coating film

The results are show n in Table 1

TABLE 1

| | Coating | | | | | | | | | |
|---|---|---|---|---|---|---|---|---|---|---|
| | (Light-based “Sparkle-Effect” Film Layer) | | | | | | | | | |
| | | | | Other | | | | | | |
| | | Randomly- | | Light-based | | | | | | |
| | | Shaped | | “Sparkle- | | Coloring | | | | |
| | | Glass | | Effect” | | Pigments | | Clear | | |
| | | (A) | | Pigments (B) | | (C) | | Top | Evaluation | |
| No. | Vehicle | Type | Amount | Type | Amount | Type | Amount | coat | Luster | ** |

Application Examples

| | | | | | | | | | | |
|---|---|---|---|---|---|---|---|---|---|---|
| 1 | 1 | A1 | 10 | — | — | — | — | 1 | 3 | 3 |
| 2 | 1 | A1 | 3 | — | — | — | — | 1 | 2-3 | 2 |
| 3 | 1 | A1 | 20 | — | — | — | — | 1 | 3-4 | 3 |
| 4 | 1 | A1 | 7 | B1 | 3 | — | — | 1 | 3 | 3 |
| 5 | 1 | A1 | 7 | B2 | 3 | — | — | 1 | 3 | 3 |
| 6 | 1 | A1 | 10 | — | — | C1 | 4 | 1 | 3 | 3 |
| 7 | 1 | A1 | 7 | B1 | 3 | Cl | 4 | 1 | 3 | 3 |
| 8 | 1 | A2 | 10 | — | — | — | — | 1 | 3 | 3 |
| 9 | 1 | A2 | 7 | B1 | 3 | Cl | 4 | 1 | 3 | 3 |
| 10 | 1 | A3 | 10 | — | — | — | — | 1 | 3 | 3 |
| 11 | 1 | A3 | 7 | B1 | 3 | C2 | 4 | 1 | 3 | 3 |
| 12 | 2 | A1 | 10 | — | — | — | — | 1 | 4 | 3 |
| 13 | 2 | A2 | 7 | B1 | 3 | Cl | 4 | 1 | 4 | 3 |
| 14 | 1 | A1 | 10 | — | — | — | — | 2 | 3 | 3 |
| 15 | 1 | A1 | 5 | B3 | 5 | — | — | 1 | 3 | 3 |
| 16 | 1 | A1 | 5 | B3 | 5 | C2 | 4 | 1 | 3 | 3 |
| 17 | 1 | A4 | 10 | — | — | — | — | 1 | 3 | 3 |
| 18 | 1 | A4 | 5 | B3 | 5 | — | — | 1 | 3 | 3 |
| 19 | 1 | A4 | 5 | B3 | 5 | C2 | 2 | 1 | 3 | 3 |

CE*

| | | | | | | | | | | |
|---|---|---|---|---|---|---|---|---|---|---|
| 1 | 1 | A5 | 10 | — | — | — | — | 1 | 1 | 1 |
| 2 | 1 | A6 | 7 | B1 | 3 | — | — | 1 | 1 | 1 |
| 3 | 1 | A1 | 10 | — | — | — | — | 1 | 1-2 | 1 |

CE* = Comparison Examples
** = Heat barrier effect
“Amount” means parts by weight of the entire coating composition
Randomly -Shaped Glass (A):

| | |
|---|---|
| A1: D₁₀ = 2 μm, D₉₀ = 20 μm, clear | Average aspect ratio D₉₀ = 2.7 |
| A2: D₁₀ = 2 μm, D₉₀ = 30 μm, clear | Average aspect ratio D₉₀ = 2 |
| A3: D₁₀ = 2 μm, D₉₀ = 12 μm, clear | Average aspect ratio D₉₀ = 1.6 |
| A4: D₁₀ = 3 μm, D₉₀ = 12 μm, green | Average aspect ratio D₉₀ = 1.6 |

Comparison Examples: Glass Flakes coated with Titanium Dioxide:

A5: D₁₀ = 2 μm, D₉₀ = 230 μm, clear, flake
A6: D₁₀ = 18 μm, D₉₀ = 34 μm, clear, flake

Other Light-based “Sparkle-Effect” Pigments (B)

B1: “ALMI-PASTE SSP-303 AR” ™ (D₁₀ = 12 μm, D₆₀ = 50 μm:
Manufactured by Silber Line)
B2: Interference Mica “EXTERIOR MEARLIN BRIGHT SILVER 139Z” ™

(D₁₀ = 5 μm, D₉₀ = 35 μm: Manufactured by ENGELHARDT)

B3: clear glass beads (D₁₀ = 0.3 μm, D₉₀ = 12 μm)

Coloring Pigments (C)

C1: “PALOMA BLUE B-4730” ™ (Manufactured by BAYER)
C2: “HELIOCONE GREEN L-9361” ™ (Manufactured by BASF)

### RESULTS

The data presented in Table 1 indicates that in each of Application Examples 1 to 19 where a film coating was constructed by the coating film-forming method of the invention comprising the glass material, a multilayer film expressing a markedly intense sparkling sheen in both the face color and the down flop color, as well as an advantageous heat barrier effect, could be invariably obtained. On the other hand, in any of Comparative Examples 1 to 3, no intense sparkling sheen could be obtained in the down flop color, nor was a heat barrier effect obtained.

Evaluation Criteria for Application Examples 20-38 and Comparative Examples 4-7

Sheen: Each sheen perceived when each sample sheet was viewed approximately from the front (face color) and from an oblique direction (down flop color) was evaluated by gross observation on the following scoring scale.

4-Markedly intense sparkling sheen in both the face color and the down flop color

3-Intense sparkling sheen in both the face color and the down flop color

2-Slight sparkling sheen in both the face color and the down flop color

1-No intense sparkling sheen in the down flop color

Dichroism: Each sheen perceived when each sample sheet was viewed approximately from the front (face color) and from an oblique direction (down flop color) was evaluated by gross observation on the following scoring scale.

3-Marked difference in hue of the surface to be observed between the face color and the down flop color

2-Difference in hue of the surface to be observed between the face color and the down flop color

1-No difference in hue of the surface to be observed between the face color and the down flop color

The results are shown in Table 2.

TABLE 2

| | Coating | | | | | | | | | | | |
|---|---|---|---|---|---|---|---|---|---|---|---|---|
| | (Light-based “Sparkle-Effect” Film Layer) | | | | | | | | | | | |
| | | | | Flake- | | Other | | | | | | |
| | | | | shaped | | light-based | | | | | | |
| | | Randomly- | | Pigments | | “Sparkle- | | | | | | |
| | | Shaped | | composed of | | Effect” | | Coloring | | | | |
| | | Glass | | Crystallized | | Pigments | | Pigments | | Clear | | |
| | | (A) | | Polymers (LC) | | (B) | | (C) | | Top | Evaluation | |
| No. | Vehicle | Type | Amount | Type | Amount | Type | Amount | Type | Amount | coat | Luster | ** |

Application Examples

| | | | | | | | | | | | | |
|---|---|---|---|---|---|---|---|---|---|---|---|---|
| 20 | 1 | A1 | 10 | LC1 | 10 | — | — | — | — | 1 | 2 | 3 |
| 21 | 1 | A1 | 16 | LC1 | 4 | — | — | — | — | 1 | 4 | 2 |
| 22 | 1 | A1 | 10 | LC2 | 10 | — | — | — | — | 1 | 3 | 3 |
| 23 | 1 | A1 | 8 | LC1 | 3 | B1 | 4 | — | — | 1 | 2 | 3 |
| 24 | 1 | A1 | 8 | LC1 | 6 | B2 | 4 | — | — | 1 | 3 | 3 |
| 25 | 1 | A1 | 8 | LC1 | 3 | — | — | C1 | 4 | 1 | 3 | 3 |
| 26 | 1 | A1 | 8 | LC2 | 3 | B1 | 2 | C2 | 2 | 1 | 3 | 3 |
| 27 | 1 | A2 | 10 | LC3 | 10 | — | — | — | — | 1 | 3 | 3 |
| 28 | 1 | A2 | 8 | LC1 | 3 | B1 | 2 | C1 | 2 | 1 | 3 | 3 |
| 29 | 1 | A2 | 10 | LC4 | 10 | — | — | — | — | 1 | 3 | 3 |
| 30 | 2 | A1 | 10 | LC1 | 10 | — | — | — | — | 1 | 4 | 3 |
| 31 | 2 | A1 | 8 | LC1 | 5 | B1 | 2 | C1 | 2 | 1 | 4 | 3 |
| 32 | 2 | A2 | 10 | LC2 | 10 | — | — | — | — | 1 | 4 | 3 |
| 33 | 2 | A1 | 10 | LC2 | 10 | B1 | 2 | C1 | 2 | 2 | 4 | 3 |
| 34 | 2 | A1 | 6 | LC2 | 3 | B3 | 6 | — | — | 1 | 4 | 3 |
| 35 | 2 | A1 | 5 | LC2 | 3 | B3 | 5 | C2 | 2 | 1 | 4 | 3 |
| 36 | 2 | A4 | 10 | LC2 | 10 | — | — | — | — | 1 | 4 | 3 |
| 37 | 2 | A4 | 6 | LC2 | 6 | B3 | 6 | — | — | 1 | 4 | 3 |
| 38 | 2 | A4 | 5 | LC2 | 3 | B3 | 5 | C2 | 2 | 1 | 4 | 3 |

CE*

| | | | | | | | | | | | | |
|---|---|---|---|---|---|---|---|---|---|---|---|---|
| 4 | 1 | A1 | 20 | — | — | — | — | — | — | 1 | 4 | 1 |
| 5 | 1 | — | — | LC1 | 20 | B1 | 3 | — | — | 1 | 1 | 3 |
| 6 | 1 | A5 | 10 | LC1 | 10 | — | — | — | — | 1 | 1 | 3 |
| 7 | 1 | A5 | 10 | LC1 | 10 | — | — | — | — | 1 | 1 | 3 |

CE* = Comparison Examples
** = Bi-color Effect
“Amount” means parts by weight of the entire coating composition
Randomly -Shaped Glass (A):

| | |
|---|---|
| A1: D₁₀ = 2 μm, D₉₀ = 30 μm, clear | Average aspect ratio D₉₀ = 2.7 |
| A2: D₁₀ = 2 μm, D₉₀ = 30 μm, clear | Average aspect ratio D₉₀ = 2 |
| A3: D₁₀ = 2 μm, D₉₀ = 12 μm, clear | Average aspect ratio D₉₀ = 1.6 |
| A4: D₁₀ = 3 μm, D₉₀ = 12 μm, green | Average aspect ratio D₉₀ = 1.6 |

Comparison Examples: Glass Flakes coated with Titanium Dioxide:

A5: D₁₀ = 20 μm, D₉₀ = 230 μm, clear, flake
A6: D₁₀ = 16 μm, D₉₀ = 34 μm, clear, flake

Flake-shaped Pigments composed of Crystallized Polymers (LC)

LC1: “HELICONE 460 Blue” ™
LC2: “HELICONE 816 Green” ™
LC3: “HELICONE 676 Gold” ™
LC4: “HELICONE 824 Copper-Red” ™

Other Light-based “Sparkle-Effect” Pigments (B)

B1: “ALMI-PASTE 88P-303AR” ™ (D₁₀ = 12 μm, D₉₀ = 60 μm; SILBER) (Manufactured
by Silber Line)
B2: Interference Mica “EXTERIOR MEARLIN BRIGHT SILVER 139Z” ™

(D₁₀ = 5 μm, D₉₀ = 35 μm: Manufactured by ENGELHARDT)

B3: clear glass beads (D₁₀ = 5 μm, D₉₀ = 12 μm)

### RESULTS

The data presented in Table 2 indicate clearly that in Application Examples 20-38 of the present invention, wherein the film coatings were produced by the method using compositions containing the above-described glass pigment and a flaky pigment comprised of a cholesteric liquid crystal polymer, an intense sparkling sheen is expressed in both the face color and the down flop color and, at the same time, a dichroism is expressed. On the other hand, in Comparative Example 4, no dichroism was expressed, and in Comparative Examples 5 to 7, no sparkling sheen could be obtained in the down flop color.

Quantitative evaluation

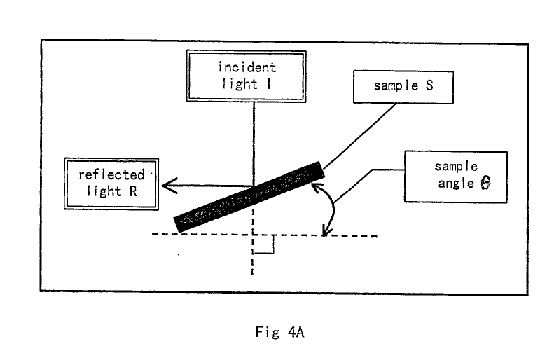

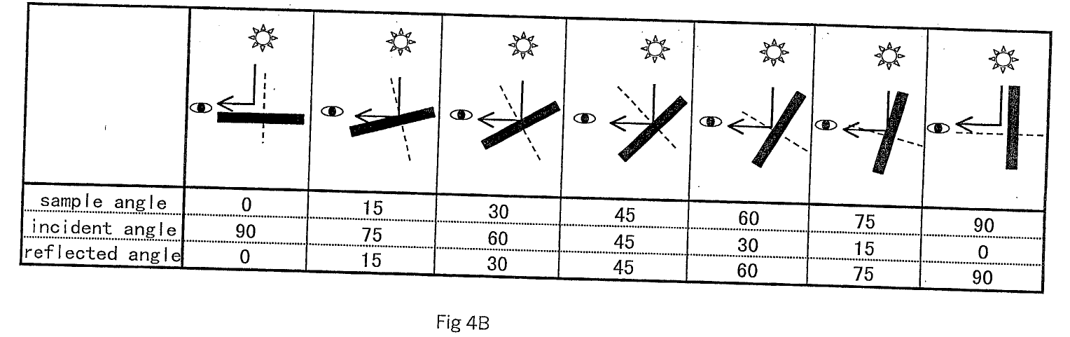

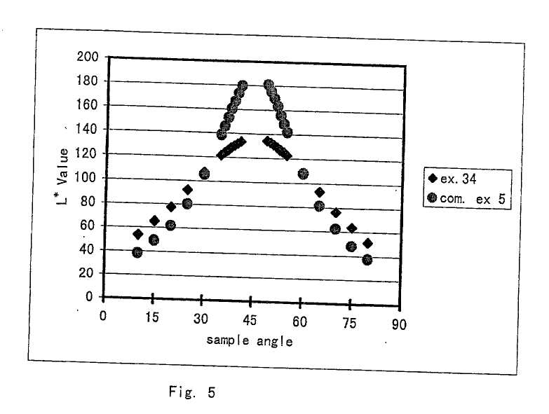

In addition to the above-described perceptive evaluation performed on the sample sheets of the Application Examples and the Comparative Examples tabulated in Tables 1 and 2 above, quantitative analysis was further performed, the results of which confirmed the findings of the perceived results. A diagram of the analysis carried out on the samples is depicted in FIGS. 4A and 4B. Incident light I was reflected from a sample S oriented at a sample angle θ, and the intensity of reflected light R was measured as various values of the sample angle θ. The empirical data for Application Example 34 and Comparative Example 5 are shown in Table 3, below, and the data is plotted as a distribution curve in FIG. 5.

TABLE 3

| incident light | reflected light | ex. 34 | com. ex 5 |
|---|---|---|---|
| 10 | 80 | 51.72 | 37.83 |
| 15 | 75 | 63.62 | 48.5 |
| 20 | 70 | 76.46 | 62.49 |
| 25 | 65 | 93 | 81.56 |
| 30 | 60 | 108.43 | 108.06 |
| 35 | 55 | 122.67 | 141.93 |
| 36 | 54 | 125.26 | 148.66 |
| 37 | 53 | 127.27 | 155.84 |
| 38 | 52 | 129.36 | 162.96 |
| 39 | 51 | 131.23 | 169.66 |
| 40 | 50 | 133.01 | 175.49 |
| 41 | 49 | 134.41 | 181.1 |
| 49 | 41 | 133.36 | 179.76 |
| 50 | 40 | 131.65 | 173.55 |
| 51 | 39 | 130 | 166.81 |
| 52 | 38 | 128.15 | 160.5 |
| 53 | 37 | 125.83 | 153.24 |
| 54 | 36 | 123.65 | 145.78 |
| 55 | 35 | 121.57 | 138.69 |
| 60 | 30 | 107.09 | 105.58 |
| 65 | 25 | 91.74 | 80.32 |
| 70 | 20 | 77.35 | 61.68 |
| 75 | 15 | 65.13 | 49.06 |
| 80 | 10 | 53.56 | 38.37 |

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A coating composition, comprising:
a carrier;
randomly shaped glass chips presenting an irregularly-shaped geometry dispersed in said carrier, said glass chips having a particle size/D₁₀-D₉₀ in a range of about 1 to 30 μm, an average maximum length/average minimum length ratio of about 1 to 10 and an average length of about of about 1-30 μm and an average aspect ratio/D₉₀ in a range of about 1 to 4.

2. The coating composition according to claim 1, wherein the particle size/D₁₀-D₉₀ is in a range of about 1 to 16 μm.

3. The coating composition according to claim 1, wherein the particle size/D₁₀-D₉₀ is in a range of about 2 to 12 μm.

4. The coating composition according to claim 1, wherein said glass chips comprise finely divided fragments of recycled glass.

5. The coating composition according to claim 1, wherein an amount of said glass chips relative to 100 parts by weight of a solid content of the coating composition is about 0.01% to about 50% by weight.

6. The coating composition according to claim 1, further comprising at least one additional luster pigment.

7. The coating composition according to claim 1, further comprising at least one additional color pigment.

8. A coating composition according to claim 1, further comprising glass beads having a particle size/D₁₀-D₉₀ in a range of about 0.1 to 12 μm.

9. The coating composition according to claim 8, wherein the particle size/D₁₀-D₉₀ is in a range of about 0.2 to 12 μm.

10. The coating composition according to claim 8, wherein the particle size/D₁₀-D₉₀ is in a range of about 0.3 to 6.5 μm.

11. The coating composition of claim 1, further comprising a flaky pigment comprised of a cholestric liquid crystal polymer.

12. The coating composition of claim 8, further comprising a flaky pigment comprised of a cholestric liquid crystal polymer.

13. A method of imparting a lustrous appearance to a surface of an article comprising forming a luster coating film over said surface, the luster coating film comprising a composition according to claim 1.

14. A method according to claim 13, comprising first forming a base coat on the surface and wherein the luster coating film is formed on the base coat.

15. A method according to claim 14, comprising forming clear top coat on the luster coating film.

16. A multilayer coating film comprising a base coat and a luster coat covering the base coat.

17. A multilayer coating film according to claim 16 further comprising a clear top coating covering the luster coating film.
